(19) United States
(12) Patent Application Publication
(10) Pub. No.: US 2025/0264826 A1
(43) Pub. Date: Aug. 21, 2025

(54) DEVELOPING DEVICE AND IMAGE FORMING APPARATUS

(71) Applicant: KYOCERA Document Solutions Inc., Osaka (JP)

(72) Inventors: Takeru NAGAMOTO, Osaka (JP); Junichi NAKAGAWA, Osaka (JP); Yuji TOYOTA, Osaka (JP)

(73) Assignee: KYOCERA Document Solutions Inc., Osaka (JP)

(21) Appl. No.: 19/047,478

(22) Filed: Feb. 6, 2025

(30) Foreign Application Priority Data
Feb. 15, 2024 (JP) 2024-021009

(51) Int. Cl. G03G 15/08

(52) U.S. Cl. CPC G03G 15/0889; G03G 15/0849; G03G 15/0891

(57) ABSTRACT

A developing device includes a developer container, a conveying member, and a developer carrying member. The conveying member has a rotation shaft, a conveying blade, a cut portion, and a dispersing portion. In the cut portion, the conveying blade is partly cut off along the longitudinal direction of the developer container. The dispersing portion is formed on an outer circumferential part of the rotation shaft, so as to face the cut portion, and extends along the radial direction of the rotation shaft. The dispersing portion has a dispersing surface having an area larger than the sectional area of the conveying blade.

### INCORPORATION BY REFERENCE

This application is based on and claims the benefit of priority from Japanese Patent Application No. 2024-021009 filed on Feb. 15, 2024, the contents of which are hereby incorporated by reference.

### BACKGROUND

The present disclosure relates to a developing device and an image forming apparatus.

In image forming apparatuses employing an electrophotographic system, such as copiers and printers, it is common to supply toner to an electrostatic latent image formed on the outer circumferential surface of an image carrying member such as a photosensitive drum to develop it into a toner image that will subsequently be transferred to a sheet. The image forming apparatus conveys developer containing toner stored in a developer container while stirring it there, to continue to uniformly form an image.

### SUMMARY

According to one aspect of the present disclosure, a developing device includes a developer container, a conveying member, and a developer carrying member. The developer container stores developer containing toner to be supplied to an image carrying member. The conveying member is rotatably supported on the developer container and conveys the developer while stirring it. The developer carrying member is rotatably supported on the developer container so as to face the image carrying member and supplies the toner in the developer container to the image carrying member. The conveying member has a rotation shaft, a conveying blade, a cut portion, and a dispersing portion. The rotation shaft extends along the longitudinal direction of the developer container. The conveying blade is helically formed on an outer circumferential part of the rotation shaft. In the cut portion, the conveying blade is partly cut off along the longitudinal direction. The dispersing portion has a dispersing surface that is formed on an outer circumferential part of the rotation shaft, so as to face the cut portion, and that extends along the radial direction of the rotation shaft. The dispersing surface has an area larger than the sectional area of the conveying blade.

### BRIEF DESCRIPTION OF THE DRAWINGS

FIG. 1 is a schematic sectional front view of an image forming apparatus according to one embodiment of the present disclosure.

FIG. 2 is a schematic sectional front view around an image forming portion in the image forming apparatus in FIG. 1.

FIG. 3 is a plan view, on a horizontal section, of a developing device of the image forming portion in FIG. 2.

FIG. 4 is a side part view of a first conveying member in the developing device in FIG. 3.

FIG. 5 is a side part view of the first conveying member as seen from the far side of FIG. 4.

FIG. 6 is a perspective partial view of the first conveying member in FIG. 4.

FIG. 7 is a side part view of a first conveying member in Modified Example 1.

FIG. 8 is a side part view of the first conveying member of Modified Example 1 as seen from the far side of FIG. 7.

FIG. 9 is a side part view of a first conveying member in Modified Example 2.

FIG. 10 is a side part view of the first conveying member in Modified Example 2 as seen from the far side of FIG. 9.

FIG. 11 is a side part view of a first conveying member in Modified Example 3.

### DETAILED DESCRIPTION

Now, an embodiment of the present disclosure will be described with reference to the drawings. Note that the description below is not meant to limit the scope of the present disclosure.

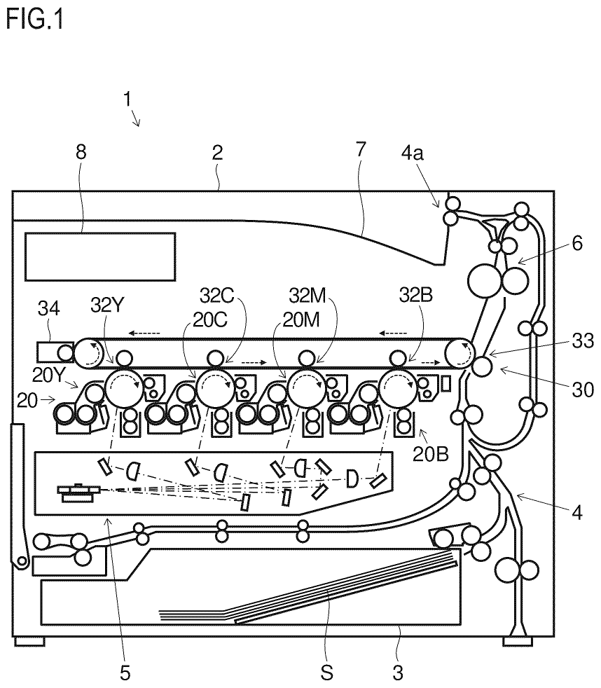

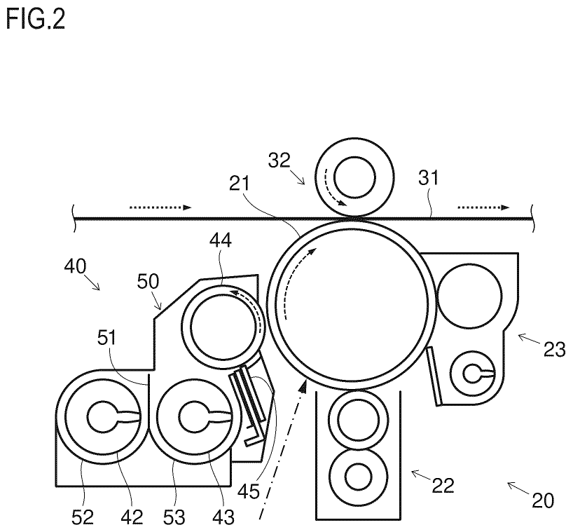

FIG. 1 is a schematic sectional front view of an image forming apparatus 1 according to the embodiment. FIG. 2 is a schematic sectional front view around an image forming portion 20 in the image forming apparatus 1 in FIG. 1. One example of the image forming apparatus 1 according to the embodiment is a tandem color printer that transfers a toner image to a sheet S using an intermediate transfer belt 31. The image forming apparatus 1 can be what is called a multifunction peripheral having functions of, for example, printing, scanning (image reading), facsimile transmission, and the like.

As shown in FIGS. 1 and 2, the image forming apparatus 1 includes, inside its body 2, a sheet feeding portion 3, a sheet conveying portion 4, an exposure portion 5, an image forming portion 20, a transferring portion 30, a fixing portion 6, a sheet ejection portion 7, and a control portion 8.

The sheet feeding portion 3 is disposed in a bottom part of the body 2. The sheet feeding portion 3 stores a plurality of unprinted sheets S and separates and feeds out one sheet S after another for printing. The sheet conveying portion 4 extends along the top-bottom direction along a side wall of the body 2. The sheet conveying portion 4 conveys the sheet S fed from the sheet feeding portion 3 to a secondary transfer portion 33 and the fixing portion 6, and ejects the sheet S after fixing through a sheet ejection port 4a to the sheet ejection portion 7. The exposure portion 5 is disposed above the sheet feeding portion 3. The exposure portion 5 exposes the image forming portion 20 to laser light controlled based on image data.

The image forming portion 20 is disposed above the exposure portion 5, below the intermediate transfer belt 31. The image forming portion 20 includes an image forming portion 20Y for yellow, an image forming portion 20C for cyan, an image forming portion 20M for magenta, an image forming portion 20B for black. These four image forming portions 20 have basically the same configuration. Thus, in the following description, except when distinction is needed, the suffixes distinguishing the colors, “Y,” “C,” “M,” and “B,” are sometimes omitted.

The image forming portion 20 includes a photosensitive drum (an image carrying member) 21 that is supported so as to be rotatable in a predetermined direction (clockwise in FIGS. 1 and 2). The image forming portion 20 further includes a charging portion 22, a developing device 40, and a drum cleaning portion 23 that are disposed around the photosensitive drum 21 along its rotational direction. Note that a primary transfer portion 32 is disposed between the developing device 40 and the drum cleaning portion 23.

The photosensitive drum 21 is formed in the shape of a cylinder extending along a horizontal direction and has, on its outer circumferential surface, a photosensitive layer formed with, for example, an amorphous silicon photosensitive member. The charging portion 22 electrostatically charges the surface (outer circumferential surface) of the photosensitive drum 21 to a predetermined surface potential. The exposure portion 5 exposes the outer circumferential surface of the photosensitive drum 21 electrostatically charged by the charging portion 22 to light to form an electrostatic latent image based on a document image on the outer circumferential surface of the photosensitive drum 21. The developing device 40 supplies toner to and thereby develops the electrostatic latent image to form a toner image. The four image forming portions 20 form toner images of different colors. The drum cleaning portion 23 performs cleaning by removing the residual toner and the like left on the outer circumferential surface of the photosensitive drum 21 after the primary transfer of the toner images to the outer circumferential surface of the intermediate transfer belt 31. In this way, the image forming portion 20 forms the image (toner image) that will be subsequently transferred to the sheet S.

The transferring portion 30 includes the intermediate transfer belt 31, the primary transfer portions 32Y, 32C, 32M, and 32B, the secondary transfer portion 33, and a belt cleaning portion 34. The intermediate transfer belt 31 is disposed above the four image forming portions 20. The intermediate transfer belt 31 is an endless intermediate transfer member that is supported so as to be rotatable in a predetermined direction (counterclockwise in FIG. 1) and to which the toner images formed at the four image forming portions 20 are primarily transferred sequentially so as to be overlayed on each other. The four image forming portions 20 are disposed in what is called a tandem arrangement, in which they are arrayed in a row from upstream to downstream in the rotational direction of the intermediate transfer belt 31.

The primary transfer portions 32Y, 32C, 32M, and 32B are disposed, across the intermediate transfer belt 31, above the image forming portions 20Y, 20C, 20M, and 20B of the corresponding colors. The secondary transfer portion 33 is disposed upstream of the fixing portion 6 with respect to the sheet conveyance direction of the sheet conveying portion 4, downstream of the four image forming portions 20Y, 20C, 20M, and 20B with respect to the rotational direction of the intermediate transfer belt 31. The belt cleaning portion 34 is disposed downstream of the secondary transfer portion 33 with respect to the rotational direction of the intermediate transfer belt 31.

The primary transfer portion 32 transfers the toner image formed on the outer circumferential surface of the photosensitive drum 21 to the intermediate transfer belt 31. In other words, the toner image is primarily transferred to the outer circumferential surface of the intermediate transfer belt 31 at the primary transfer portions 32Y, 32C, 32M, and 32B of the corresponding colors. Then as the intermediate transfer belt 31 rotates, with predetermined timing, the toner images of the four image forming portions 20 are transferred to the intermediate transfer belt 31 sequentially so as to be overlayed on each other to form a color toner image having the toner images of four colors, namely yellow, cyan, magenta, and black, overlayed on each other on the outer circumferential surface of the intermediate transfer belt 31.

The color toner image on the outer circumferential surface of the intermediate transfer belt 31 is transferred to the sheet S synchronously fed by the sheet conveying portion 4 at a secondary transfer nip portion formed in the secondary transfer portion 33. The belt cleaning portion 34 performs cleaning by removing foreign matter such as residual toner left on the outer circumferential surface of the intermediate transfer belt 31 after secondary transfer. In this way, the transferring portion 30 transfers (records) the toner image formed on the outer circumferential surface of the photosensitive drum 21 to the sheet S.

The fixing portion 6 is disposed above the secondary transfer portion 33. The fixing portion 6 heats and presses the sheet S having the toner image transferred to it to fix the toner image to the sheet S.

The sheet ejection portion 7 is disposed above the transferring portion 30. The sheet S having the toner image fixed to it and having undergone printing is conveyed to the sheet ejection portion 7. In the sheet ejection portion 7, the printed sheet (printed matter) can be retrieved upward.

The control portion 8 includes a CPU, an image processing portion, a memory, and other electronic circuits and components (none of which is shown). The CPU controls the operation of different components in the image forming apparatus 1 based on programs and data for control stored in the memory to perform processes related to the functions of the image forming apparatus 1. The sheet feeding portion 3, the sheet conveying portion 4, the exposure portion 5, the image forming portion 20, the transferring portion 30, and the fixing portion 6 individually receive instructions from the control portion 8 and operate together to perform printing on the sheet S. The memory is configured with a combination of a non-volatile memory device, such as a program ROM (read only memory) and a data ROM, and a volatile memory device, such as a RAM (random access memory).

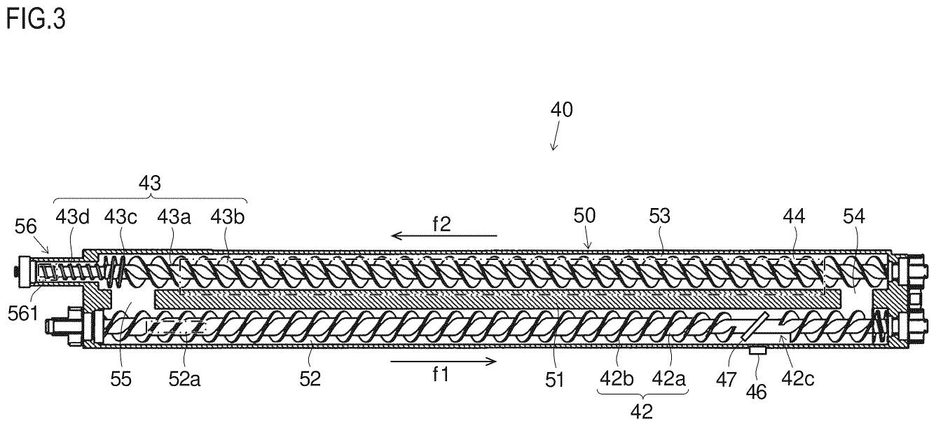

Now, the configuration of the developing device 40 will be described with reference to FIG. 3 in addition to FIG. 2. FIG. 3 is a plan view, on a horizontal section, of the developing device 40 of the image forming portion 20 in FIG. 2. Note that the developing devices 40 for different colors have basically the same configuration and thus, for their components, the suffixes distinguishing the colors will be omitted and no overlapping description will be repeated. In addition, in the following description, “axial direction” means the direction (the depth direction of the plane of FIG. 2, the lateral, left-right direction in FIG. 3) of the rotation axes of the photosensitive drum 21, a first conveying member 42, a second conveying member 43, and a developing roller 44, which extend parallel to each other.

The developing device 40 supplies toner to the outer circumferential surface of the photosensitive drum 21. The developing device 40 is removably mounted in, for example, the body 2 of the image forming apparatus 1. The developing device 40 includes a developer container 50, the first conveying member 42, the second conveying member 43, the developing roller (developer carrying member) 44, a regulation blade 45, a toner concentration sensor 46, a scraper 47, and a holding portion (dispersing portion) 42c.

The developer container 50 is in an elongated shape extending along the axial direction of the photosensitive drum 21 and is disposed with its longitudinal direction horizontal. In other words, the longitudinal direction of the developer container 50 is parallel to the axial direction of the photosensitive direction 21. The developer container 50 stores, as developer containing toner supplied to the photosensitive drum 21, two-component developer containing toner and magnetic carrier, for example.

The developer container 50 has a partition portion 51, a first conveyance chamber 52, a second conveyance chamber 53, a first communication portion 54, and a second communication portion 55.

The partition portion 51 is provided in a bottom part inside the developer container 50. The partition portion 51 is disposed substantially in a middle part of the developer container 50 along a direction (the lateral, left-right direction in FIG. 2, the top-bottom direction in FIG. 3) intersecting its longitudinal direction. The partition portion 51 is formed substantially in the shape of a plate extending along the longitudinal and top-bottom directions of the developer container 50. The partition portion 51 divides the inside of the developer container 50 into two parts lying beside each other along a direction intersecting the longitudinal direction.

The first and second conveyance chambers 52 and 53 are provided inside the developer container 50. The first and second conveyance chambers 52 and 53 are formed as a result of the partition portion 51 dividing the developer container 50. The first and second conveyance chambers 52 and 53 are disposed side by side at substantially the same height.

The second conveyance chamber 53 is disposed, in the developer container 50, so as to include a space around the developing roller 44, adjacent to the photosensitive drum 21. The first conveyance chamber 52 is disposed, in the developer container 50, in a region away from the photosensitive drum 21 across the second conveyance chamber 53. The first conveyance chamber 52 has an opening as a developer supply port 52a, through which developer is supplied into the developer container 50. The first conveyance chamber 52 has a first conveying member 42, which conveys the developer in a first direction f1. The second conveyance chamber 53 has a second conveying member 43, which conveys the developer in a second direction f2, that is, the direction opposite to the first direction f1.

The first and second communication portions 54 and 55 are disposed one beyond each end of the partition portion 51 along its longitudinal direction. Through the first and second communication portions 54 and 55, the first and second conveyance chambers 52 and 53 communicate with each other in a direction intersecting the longitudinal direction of the partition portion 51 (lateral, left-right direction in FIG. 2, top-bottom direction in FIG. 3), that is., the thickness direction of the partition portion 51 substantially in the shape of a plate. In other words, through the first and second communication portions 54 and 55, the first and second conveyance chambers 52 and 53 communicate with each other in opposite end parts of them in their longitudinal directions.

Through the first communication portion 54, the downstream end of the first conveyance chamber 52 in the first direction f1 communicates with the upstream end of the second conveyance chamber 53 in the second direction f2. In the first communication portion 54, developer is conveyed from the first conveyance chamber 52 to the second conveyance chamber 53. Through the second communication portion 55, the downstream end of the second conveyance chamber 53 in the second direction f2 communicates with the upstream end of the first conveyance chamber 52 in the first direction f1. In the second communication portion 55, developer is conveyed from the second conveyance chamber 53 to the first conveyance chamber 52.

The first conveying member 42 is disposed in the first conveyance chamber 52. The second conveying member 43 is disposed in the second conveyance chamber 53. The first and second conveying members 42 and 43 are disposed side by side substantially at the same height. The second conveying member 43 is disposed close to and extends parallel to the developing roller 44. The first and second conveying members 42 and 43 are supported on the developer container 50 so as to be rotatable about axes extending in a horizontal direction, parallel to the developing roller 44.

The first and second conveying members 42 and 43 have basically the same configuration. The first conveying member 42 has a first conveying blade 42b helically formed on an outer circumferential part of a rotation shaft 42a extending along the longitudinal direction of the developer container 50. In the embodiment, the first conveying member 42 has two first conveying blades 42b. The second conveying member 43 has a second conveying blade 43b helically formed on an outer circumferential part of a rotation shaft 43a extending along the longitudinal direction of the developer container 50. In the embodiment, the second conveying member 43 has two second conveying blades 43b.

In the first conveyance chamber 52, the first conveying member 42 conveys developer while stirring it in the first direction f1, which points from the second communication portion 55 to the first communication portion 54 along the axis of rotation. In the second conveyance chamber 53, the second conveying member 43 conveys developer while stirring it in the second direction f2, which points from the first communication portion 54 to the second communication portion 55 along the axis of rotation. Accordingly, the first and second conveying members 42 and 43 convey developer while stirring it in directions opposite to each other along their longitudinal direction to circulate the developer in a predetermined circulation direction.

The developing roller 44 is disposed, in the developer container 50, above the second conveying member 43 so as to face the photosensitive drum 21. The developing roller 44 is supported on the developer container 50 so as to be rotatable about an axis which extends parallel to the axis of the photosensitive drum 21.

The developing roller 44 has a part of its outer circumferential surface exposed through the developer container 50 so as to face and lie close to the photosensitive drum 21. The developing roller 44 carries, on its outer circumferential surface, toner to be supplied to the outer circumferential surface of the photosensitive drum 21 in a region where the developing roller 44 faces the photosensitive drum 21. The developing roller 44 carries the toner in the second conveyance chamber 53 of the developer container 50 to supply it to the photosensitive drum 21. In other words, the developing roller 44 makes the toner in the second conveyance chamber 53 adhere to an electrostatic latent image on the outer circumferential surface of the photosensitive drum 21 to form a toner image.

The regulation blade 45 is disposed upstream, in the rotation direction of the developing roller 44, of the region where the developing roller 44 faces the photosensitive drum 21. The regulation blade 45 is disposed close to and opposite the developing roller 44 with a predetermined gap between the tip of the regulation blade 45 and the outer circumferential surface of the developing roller 44. The regulation blade 45 extends over the entire region of the developing roller 44 along its axial direction. The regulation blade 45 regulates the layer thickness of the developer carried on the outer circumferential surface of the developing roller 44 that passes through the gap between the tip of the regulation blade 45 and the outer circumferential surface of the developing roller 44.

The toner concentration sensor 46 is disposed in a wall portion of the first conveyance chamber 52 along its longitudinal direction (the first direction f1). The toner concentration sensor 46 is disposed opposite the first conveying member 42. In the embodiment, the toner concentration sensor 46 is implemented with a headless sensor. The headless sensor as the toner concentration sensor 46 has its sensing surface embedded in the inner wall of the first conveyance chamber 52. The toner concentration sensor 46 senses the concentration of toner in developer.

Specifically, the toner concentration sensor 46 is a sensor of a magnetic permeability sensing type that senses the change of the magnetic permeability of two-component developer to find toner concentration (the mixture ratio of toner T to carrier C in developer, i.e., T/C). As the ratio of toner to carrier in the developer in the first conveyance chamber 52 changes, the magnetic permeability also changes so that the output signal from the toner concentration sensor 46 changes accordingly. Based on the output signal from the toner concentration sensor 46, the control portion 8 controls the starting and stopping of the supply of the developer (toner and carrier) to the developing device 40.

In relation to the toner concentration sensor 46, the first conveying member 42 has a scraper 47 fitted to it. The scraper 47 is fixed to the rotation shaft 42a of the first conveying member 42 via a holding portion 42e in the region opposite the toner concentration sensor 46. The scraper 47 and its surroundings will be described in detail later.

As the first and second conveying members 42 and 43 rotates, the developer in the developer container 50 circulates between the first and second conveyance chambers 52 and 53 through the first and second communication portions 54 and 55 in the predetermined circulation direction. Meanwhile, the toner in the developer container 50 is stirred and electrostatically charged so as to be carried on the outer circumferential surface of the developing roller 44. The developer carried on the outer circumferential surface of the developing roller 44 has its layer thickness regulated by the regulation blade 45 and is subsequently conveyed, as the developing roller 44 rotates, to the region where the developing roller 44 faces the photosensitive drum 21. When a predetermined developing voltage is applied to the developing roller 44, under the potential difference relative to the potential on the surface (outer circumferential surface) of the photosensitive drum 21, the toner in the developer carried on the outer circumferential surface of the developing roller 44 moves to the outer circumferential surface of the photosensitive drum 21 in the facing region. In this way, the electrostatic latent image on the outer circumferential surface of the photosensitive drum 21 is developed with toner.

The developer container 50 further has a discharging portion 56. The discharging portion 56 is provided further downstream of the downstream end of the second conveyance chamber 53 in the second direction f2. The discharging portion 56 is connected to the second conveyance chamber 53. The insides of the discharging portion 56 and the second conveyance chamber 53 communicate with each other. The inner diameter of the discharging portion 56 is smaller than that of the second conveyance chamber 53. The discharging portion 56 has a developer discharge port 561.

Note that the rotation shaft 43a of the second conveying member 43 extends continuously into the discharging portion 56. One end of the rotation shaft 43a along its axial direction is rotatably supported on the developer container 50 at the downstream end of the discharging portion 56 with respect to the second direction f2 along the second conveyance chamber 53.

The developer discharge port 561 is disposed at the downstream end of the discharging portion 56 with respect to the second direction f2 along the second conveyance chamber 53. The developer discharge port 561 is open, for example, below the rotation shaft 43a of the second conveying member 43. Through the developer discharge port 561, excess developer in the developer container 50 is discharged out of it.

The second conveying member 43 further includes, along with the second conveying blade 43b, a regulation blade 43c and a discharging blade 43d. These three blades are provided in the order of, from the second conveyance chamber 53 to the discharging portion 56, the second conveying blade 43b, the regulation blade 43c, and the discharging blade 43d. Like the second conveying blade 43b, the regulation blade 43c and the discharging blade 43d are provided integrally with the rotation shaft 43a and are helically formed along the axial direction of the rotation shaft 43a on its outer circumferential part.

The regulation blade 43c is disposed, in the second conveyance chamber 53, downstream of the second conveying blade 43b with respect to the second direction f2 along the second conveyance chamber 53. The regulation blade 43c faces a connecting portion of the second conveyance chamber 53 with the discharge portion 56 along the axial direction of the rotation shaft 43a.

The regulation blade 43c winds in the opposite direction to the second conveying blade 43b. This allows regulation blade 43c to block the developer conveyed to around the downstream end of the second conveyance chamber 53 and thereby restrict the movement of the developer to the discharging portion 56. Note that the pitch of the regulation blade 43c is smaller than that of the second conveying blade 43b.

An outer circumferential part of the regulation blade 43c forms a predetermined gap (clearance) with the inner surface of the developer container 50. The developer exceeding a predetermined amount in the second conveyance chamber 53 is conveyed, as excess developer, toward the discharging portion 56 through the gap between the outer circumferential part of the regulation blade 43c and the inner surface of the developer container 50.

The discharging blade 43d is disposed, in the discharging portion 56, downstream of the regulation blade 43c with respect to the second direction f2 along the second conveyance chamber 53. The discharging blade 43d winds in the same direction as the second conveying blade 43b. In other words, the conveyance direction of developer in the discharging portion 56 is the same as the second direction f2 along the second conveyance chamber 53. Accordingly, the discharging blade 43d conveys excess developer in the discharging portion 56 toward the developer discharge port 561. Note that the outer diameter of the discharging blade 43d is smaller than those of the second conveying blade 43b and the regulation blade 43c. The pitch of the discharging blade 43d is smaller than that of the second conveying blade 43b.

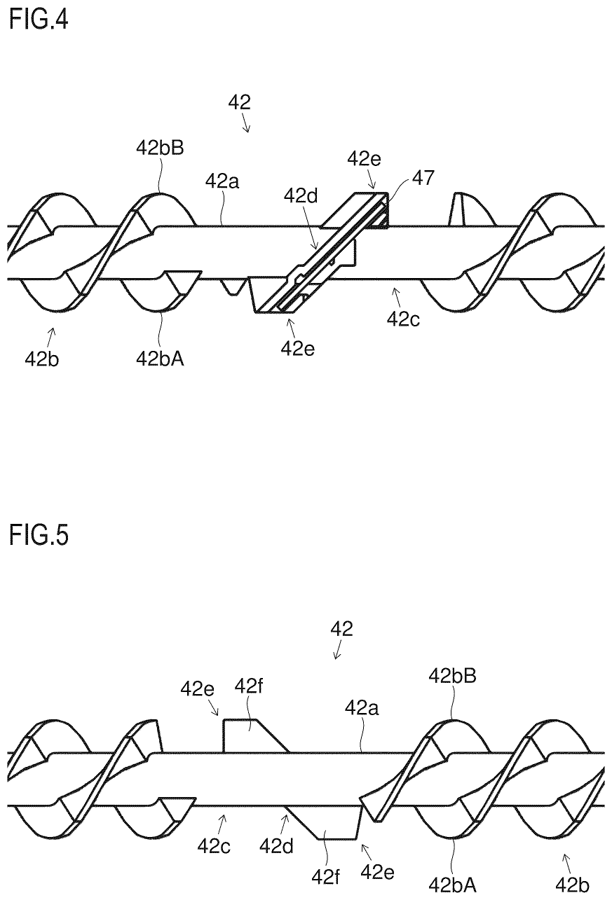

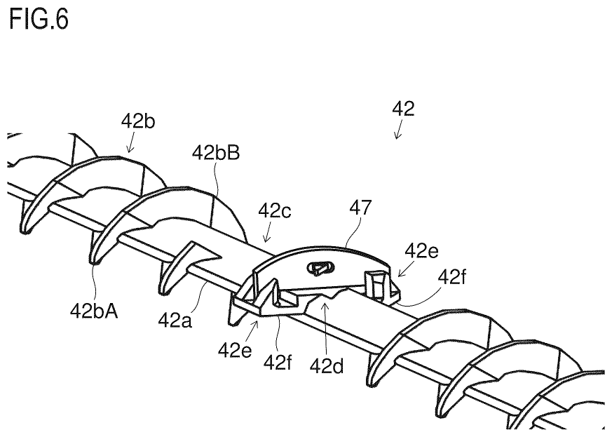

Now, the configuration of the developing device 40 will be described in more detail with reference to FIGS. 4, 5, and 6 in addition to FIG. 3. FIG. 4 is a side part view of the first conveying member 42 in the developing device 40 in FIG. 3. FIG. 5 is a side part view of the first conveying member 42 as seen from the far side of FIG. 4. FIG. 6 is a perspective partial view of the first conveying member 42 in FIG. 4.

As shown in FIGS. 4, 5, and 6, the first conveying member 42 has a cut portion 42c. As shown in FIG. 3, the cut portion 42c is formed in a region opposite the toner concentration sensor 46. In the cut portion 42c located in the region opposite the toner concentration sensor 46, the first conveying blade 42b is partly cut off along the longitudinal direction (the first direction f1). Note that, in the embodiment, in the cut portion 42c, two first conveying blades 42bA and 42bB are cut off over different lengths from each other along the axial direction of the rotation shaft 42a (the lateral, left-right directions in FIGS. 4 and 5).

With the above configuration, since the first conveying blade 42b has the cut portion 42c in the region opposite the toner concentration sensor 46, even at an increased developer conveyance speed, developer easily stagnates near the toner concentration sensor 46. This helps stabilize the sensing value of toner concentration and makes it possible to maintain an adequate amount of toner in the developer container 50.

The scraper 47 is, in the cut portion 42c, fixed to the rotation shaft 42a of the first conveying member 42 via a fitting portion 42d. As shown in FIG. 6, the scraper 47 is formed in the shape of a fan as seen from the axial direction of the rotation shaft 42a. The scraper 47 is disposed substantially at the same inclination as the first conveying blade 42b, which is helical with respect to the axial direction of the rotation shaft 42a.

The scraper 47 can be implemented with a base member formed of a flexible film (clastic member) such as a PET (polyethylene terephthalate) film of which the surface is laid with a sheet of fabric such as felt or unwoven fabric. The scraper 47, by rotating together with the rotation shaft 42a, moves the developer opposite the toner concentration sensor 46. New developer is then supplied to the region opposite the toner concentration sensor 46.

With the above configuration, since the scraper 47 is provided in the cut portion 42c, excessive stagnation of developer near the toner concentration sensor 46 can be avoided. This makes it possible to properly sense the toner concentration in the developer container 50.

The fitting portion 42d is disposed, like the scraper 47, substantially at the same inclination as the first conveying blade 42b, which is helical with respect to the axial direction of the rotation shaft 42a. The fitting portion 42d is, in the cut portion 42c, provided integrally with an outer circumferential part of the rotation shaft 42a. Note that, while in the embodiment, the fitting portion 42d is provided integrally with the rotation shaft 42a, it can be provided as a member separate from the rotation shaft 42a.

In each end part of the fitting portion 42d along the axial direction, a holding portion (dispersing portion) 42e that holds the scraper 47 is formed. The holding portion 42e grips and holds the scraper 47 substantially along the axial direction of the rotation shaft 42a.

The holding portion (dispersing portion) 42c has, in each end part of it in the circumferential direction of the rotation shaft 42a, a circumferential end surface (dispersing surface) 42f extending in the radial direction of the rotation shaft 42a. In other words, the circumferential end surface (dispersing surface) 42f is formed on an outer circumferential part of the rotation shaft 42a, so as to face the cut portion 42c and extends along the radial direction of the rotation shaft 42a. As shown in FIG. 5, the area of the circumferential end surface 42f is larger than the sectional area of the first conveying blade 42b (42bA).

With the above configuration, since the area of the circumferential end surface 42f as the dispersing surface is larger than the sectional area of the first conveying blade 42b, in the holding portion 42c as the dispersing portion, developer can be supplied in a direction (e.g., the circumferential direction of the rotation shaft 42a) different from the conveyance direction (the first direction f1) of developer by the first conveying blade 42b. In other words, in the holding portion 42c, the dispersion (stirring) of developer can be promoted. This improves the dispersibility of developer in the developer container 50 and makes it possible to uniformly form an image with suppressed uneven density.

As shown in FIG. 5, the circumferential end surface 42f is formed parallel to the axial direction of the rotation shaft 42a and points in a direction substantially orthogonal to the axial direction of the rotation shaft 42a. With this configuration, in the holding portion 42e as the dispersing portion, developer can be supplied in a direction orthogonal to the conveyance direction (first direction f1) of developer by the first conveying blade 42b, that is, in the circumferential direction of the rotation shaft 42a. This helps more effectively promote the dispersion (stirring) of developer in the holding portion 42c.

The circumferential end surface 42f is disposed at the edge, so as to face the cut portion 42c, of the holding portion 42e that holds the scraper 47.

With the above configuration, since the holding portion 42e that holds the scraper 47 has the circumferential end surface (dispersing surface) 42f, it is possible to enhance the effect of moving the developer near the toner concentration sensor 46 by the action of the circumferential end surface 42f moving as the rotation shaft 42a rotates. This helps avoid excessive stagnation of developer near the toner concentration sensor 46. In this way, it is possible to properly sense the toner concentration as well as to improve the dispersibility of developer in the developer container 50.

By using the holding portion 42e of the scraper 47 as the dispersing portion for improving the dispersibility of developer, it is possible to secure a sufficient area to accommodate the holding portion 42e. This helps give the holding of the scraper 47 increased holding strength.

Now, the effects of the embodiment will be described. Table 1 shows the results of an evaluation of the conveyance speed and the dispersibility of developer in the developing devices of practical and comparative examples. For each of the developing devices 40 of the practical examples and the developing devices of the comparative examples, an evaluation was made of the effect of the area factor of the dispersing surface (assuming that the sectional area of the conveying blade=1.0) on the conveyance speed and the dispersibility of developer.

TABLE 1

| | AREA | | |
|---|---|---|---|
| | FACTOR | | |
| | OF | | |
| | DISPERSING | | |
| | SURFACE | | |
| | (WITH | | |
| | SECTIONAL | | |
| | AREA | | |
| | OF | CONVEYANCE | DISPERS- |
| | CONVEYING | SPEED | IBILITY |
| | BLADE = | OF | OF |
| | 1.0) | DEVELOPER | DEVELOPER |
| COMPARATIVE | 1.0 | GOOD | POOR |
| EXAMPLE 1 | | | |
| PRACTICAL | 1.5 | GOOD | GOOD |
| EXAMPLE 1 | | | |
| PRACTICAL | 3.0 | GOOD | GOOD |
| EXAMPLE 2 | | | |
| PRACTICAL | 6.0 | GOOD | GOOD |
| EXAMPLE 3 | | | |
| PRACTICAL | 9.0 | GOOD | GOOD |
| EXAMPLE 4 | | | |
| COMPARATIVE | 10.0 | POOR | GOOD |
| EXAMPLE 2 | | | |

The area factor of the dispersing surface of the first conveying member in the developing device of Comparative Example 1 was 1.0 as compared with the sectional area of the first conveying blade of the first conveying member, that is, those areas were equal. The area factors of the dispersing surface (the circumferential end surface 42f) of the first conveying member 42 in the developing devices 40 of Practical Examples 1, 2, 3, and 4 were respectively 1.5, 3.0, 6.0, and 9.0 as compared with the sectional area of the first conveying blade 42b of the first conveying member 42. The area factor of the dispersing surface of the first conveying member in the developing device of Comparative Example 2 was 10.0 as compared with the sectional area of the first conveying blade of the first conveying member.

With respect to Table 1, printing was performed with a print ratio of 40% per sheet surface; if the developer conveyance speed exceeded a rate at which a sufficient amount of developer could be supplied, the developer conveyance speed was evaluated as “GOOD”; if the developer conveyance speed was equal to or less than that rate, the developer conveyance speed was evaluated as “POOR”. In addition, a predetermined amount of developer was supplied through the developer supply port 52a in the developing device 40; if the mixture ratio of toner to carrier (T/C) in the developer having reached a downstream part of the first conveying member 42 in the conveyance direction of developer (where the toner concentration sensor 46 is disposed) had a difference within 1% from the T/C obtained after complete dispersion, the developer dispersibility was evaluated as “GOOD”; if it had a difference of 1% or more, the developer dispersibility was evaluated as “POOR.”

According to Table 1, with the configuration of Comparative Example 1, since the area factor of the dispersing surface of the first conveying member equals to the sectional area of the first conveying blade, while the conveyance speed of developer is sufficient, the dispersibility of developer is unsatisfactory. With the configuration of Comparative Example 2, since the area factor of the dispersing surface of the first conveying member is 10.0 as compared with the sectional area of the first conveying blade, while the dispersibility of developer is sufficient, the conveyance speed of developer is unsatisfactory. This results from the dispersing surface being so configured as to block the gap between the conveying blades adjacent along the axial direction, hampering developer from moving in the conveyance direction, and causing an extreme drop in the conveyance speed of developer.

With the configurations of Practical Examples 1, 2, 3, and 4, the evaluation results are good both in the conveyance speed and the dispersibility of developer. That is, setting the area of the dispersing surface (the circumferential end surface 42f) of the first conveying member 42 to be 1.4 to 9 times the sectional area of the first conveying blade 42b helps maintain sufficient dispersibility of developer without adversely affecting the conveyance speed of developer.

Now, modified examples of a developing device 40 will be described.

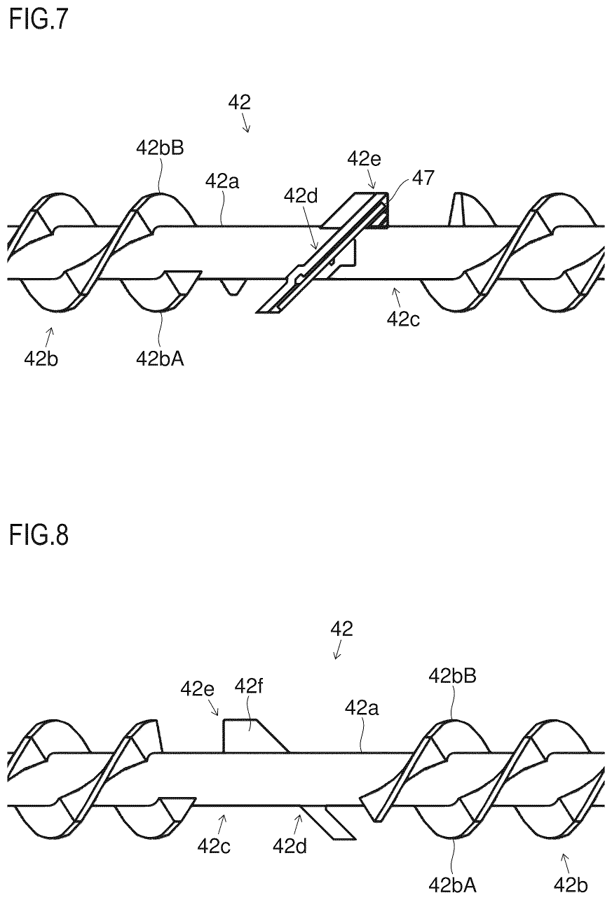

FIG. 7 is a side part view of a first conveying member 42 in Modified Example 1. FIG. 8 is a side part view of the first conveying member 42 of Modified Example 1 as seen from the far side of FIG. 7. The first conveying member 42 of Modified Example 1 has a holding portion (dispersing portion) 42e of a scraper 47 formed only at one side of the scraper 47 with respect to the axial and circumferential directions of the rotation shaft 42a, that is, at the right side in FIG. 7 (at the left side in FIG. 8). In other words, the circumferential end surface (dispersing surface) 42f is formed at one place on the rotation shaft 42a with respect to its axial direction.

Also with the above configuration of Modified Example 1, as with the embodiment described previously with reference to FIGS. 4, 5, and 6, the dispersion (stirring) of developer can be promoted in the holding portion 42e. This improves the dispersibility of developer in the developer container 50 and makes it possible to uniformly form an image with suppressed uneven density.

Providing dispersing surfaces (dispersion portions) for developer at three or more places necessitates providing many cut portions 42c in the first conveying member 42, and this requires the first conveying blade 42b to be divided at more places. This may lead to difficulty in conveying developer. In order to obtain a suitable conveyance speed combined with a suitable dispersibility of developer, it is preferable to form the dispersing surface (dispersing portion) for developer at one or two places on the rotation shaft 42a with respect to its axial direction.

If the scraper 47 is provided on the conveying member, it is preferable to provide the holding portion (dispersing portion) 42e at each end of the scraper 47 along its axial direction. This helps give the holding of the scraper 47 increased holding strength.

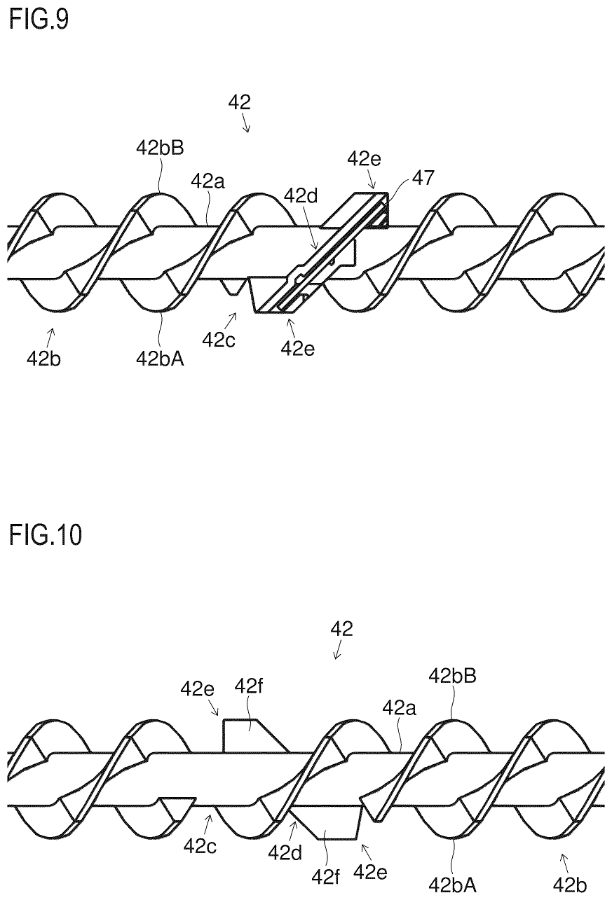

FIG. 9 is a side part view of a first conveying member 42 in Modified Example 2. FIG. 10 is a side part view of the first conveying member 42 in Modified Example 2 as seen from the far side of FIG. 9. The first conveying member 42 in Modified Example 2 has two first conveying blades 42bA and 42bB; while one first conveying blades 42bB has a cut portion 42c and a fitting portion 42d (holding portion 42e), the other first conveying blade 42bA does not. In the region of the first conveying blade 42bB where the cut portion 42c and the fitting portion 42d (holding portion 42e) are provided, the first conveying blade 42bA extends continuously along the axial direction.

Also with the above configuration of Modified Example 2, as with the embodiment described previously with reference to FIGS. 4, 5, and 6, the dispersion (stirring) of developer can be promoted in the holding portion 42e. This improves the dispersibility of developer in the developer container 50 and makes it possible to uniformly form an image with suppressed uneven density.

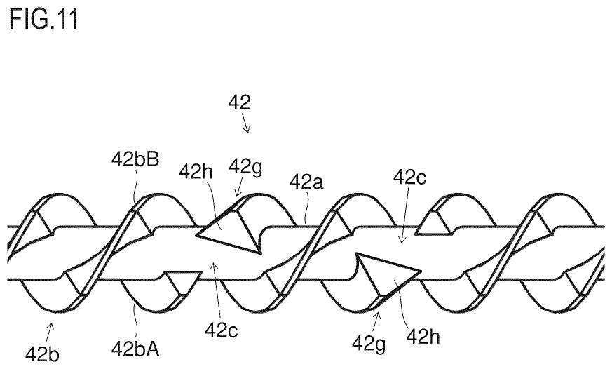

FIG. 11 is a side part view of a first conveying member 42 in Modified Example 3. The first conveying member 42 in Modified Example 3 does not have either a scraper 47 or a fitting portion 42d (holding portion 42e) like those in the above embodiment. The first conveying member 42 in Modified Example 3 has two first conveying blades 42bA and 42bB; while one first conveying blades 42bA has a cut portion 42c; the other first conveying blades 42bB does not. The first conveying blade 42bB extends continuously along the axial direction.

The cut portion 42c is formed one at two places apart from each other on the first conveying blade 42bA along its axial direction. The first conveying blade 42bA has two dispersing portions 42g that include dispersing surfaces 42h disposed so as to face the cut portions 42c at those two places respectively. The two dispersing surfaces 42h are formed at opposite end parts of a region of the first conveying blade 42bA between the two cut portions 42c along its axial direction.

The two dispersing surfaces 42h are formed on an outer circumferential part of a rotation shaft 42a, extends along the radial direction of the rotation shaft 42a, and has an area larger than the sectional area of the other part of the first conveying blade 42bA. The dispersing surfaces 42h are formed orthogonally to the extension direction of the first conveying blade 42bA, which helically extends. In other words, the dispersing surfaces 42h are formed so as to incline with respect to the axial direction of the rotation shaft 42a.

Also with the configuration of the above Modified Example 3, as with the embodiment described previously with reference to FIGS. 4, 5, and 6, the dispersion (stirring) of developer is promoted in the dispersing portion 42g. This improves the dispersibility of developer in the developer container 50 and makes it possible to uniformly form an image with suppressed uneven density.

The dispersing portion 42g (dispersing surface 42h) for developer can be formed only at one side along the axial direction. In the region of the first conveying blade 42bA between the two cut portions 42c along the axial direction, the other first conveying blades 42bB too can have a cut portion formed in it as a region where no part of the first conveying blade 42bB lies.

While an embodiment of the present disclosure is described herein, it is not meant to limit the scope of the present disclosure, which can thus be implemented with various modifications made without departing from the spirit of the present disclosure.

What is claimed is:

1. A developing device comprising:
a developer container that stores developer containing toner to be supplied to an image carrying member;
a conveying member that is rotatably supported on the developer container, the conveying member conveying the developer while stirring the developer; and
a developer carrying member that is rotatably supported on the developer container so as to face the image carrying member, the developer carrying member supplying the toner in the developer container to the image carrying member,
wherein
the conveying member has:
a rotation shaft that extends along a longitudinal direction of the developer container;
a conveying blade that is helically formed on an outer circumferential part of the rotation shaft;
a cut portion in which the conveying blade is partly cut off along the longitudinal direction; and
a dispersing portion having a dispersing surface formed on an outer circumferential part of the rotation shaft, so as to face the cut portion, and extending along a radial direction of the rotation shaft, the dispersing surface having an area larger than a sectional area of the conveying blade.

2. The developing device according to claim 1, wherein
the area of the dispersing surface is 1.4 to 9 times the sectional area of the conveying blade.

3. The developing device according to claim 1, wherein
the dispersing surface is formed on a side surface of the conveying blade so as to face the cut portion.

4. The developing device according to claim 1, wherein
the dispersing surface is formed parallel to an axial direction of the rotation shaft.

5. The developing device according to claim 1, wherein
the dispersing surface is formed at one or two places on the rotation shaft with respect to an axial direction thereof.

6. The developing device according to claim 1 further comprising:
a toner concentration sensor that is disposed in a wall portion of the developer container along a longitudinal direction thereof, opposite the conveying member, the toner concentration sensor sensing a concentration of the toner in the developer,
wherein
the conveying member has:
the cut portion that is formed in a region opposite the toner concentration sensor;
a scraper that is fixed to the rotation shaft in the cut portion, the scraper moving the developer opposite the toner concentration sensor; and
a holding portion that is formed on the rotation shaft in the cut portion, the holding portion holding the scraper and serving as the dispersing portion, and
the holding portion extends along the radial direction of the rotation shaft on each end part of the rotation shaft in a circumferential direction thereof, the holding portion having the dispersing surface disposed at an edge facing the cut portion.

7. An image forming apparatus comprising the developing device according to claim 1.
